(19) United States
(12) Patent Application Publication
(10) Pub. No.: US 2009/0128792 A1
(43) Pub. Date: May 21, 2009

(54) Lithographic apparatus and method

(75) Inventors: Rudy Jan, Maria Pellens, Overpelt (BE); Keith Frank Best, San Jose, CA (US); Richard Joseph Travers, Atkinson, NH (US); Frederick William Hafner, Effort, PA (US); Vinyu Greenlee, Gilbert, AZ (US)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/285,602

(22) Filed: Oct. 9, 2008

Related U.S. Application Data
(60) Provisional application No. 60/960,906, filed on Oct. 19, 2007.

(51) Int. Cl. G03B 27/42; G03B 27/32; G01B 11/00

(52) U.S. Cl. 355/53; 355/77; 356/401

(57) ABSTRACT

A method is disclosed that includes introducing a substrate into a pre-aligner of a lithographic apparatus, using a detector to measure the location of an alignment mark provided on a side of the substrate which is opposite to the location of the detector, and after measurement, putting the substrate onto a substrate table of the lithographic apparatus, the substrate being positioned on the substrate table such that the alignment mark provided on the opposite side of the substrate is visible through a window of the substrate table.

This application claims priority and benefit under 35 U.S.C. §119(e) to U.S. Provisional Patent Application No. 60/960,906, filed Oct. 19, 2007, the foregoing application incorporated herein in its entirety by reference.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

It is desirable to provide a lithographic apparatus or method which obviates or mitigates one or more of the problems of the prior art, whether identified herein or elsewhere.

### SUMMARY

According to an aspect of the invention, there is provided a lithographic apparatus, comprising a projection system configured to project a patterned radiation beam onto a target portion of a substrate; a substrate table configured to position the substrate such that the patterned beam is incident upon the substrate, the substrate table comprising a window; and a pre-aligner comprising a detector configured to view an alignment mark provided on a side of a substrate which is opposite to the location of the detector, and a controller arranged to measure the location of the alignment mark provided on the opposite side of the substrate, and to position the substrate onto the substrate table such that the alignment mark provided on the opposite side of the substrate is visible through the window of the substrate table.

According to an aspect of the invention, there is provided a method, comprising introducing a substrate into a pre-aligner of a lithographic apparatus; using a detector to measure the location of an alignment mark provided on a side of the substrate which is opposite to the location of the detector; and after measurement, putting the substrate onto a substrate table of the lithographic apparatus, the substrate being positioned on the substrate table such that the alignment mark provided on the opposite side of the substrate is visible through a window of the substrate table.

According to an aspect of the invention, there is provided a calibration method in which a substrate bearing an alignment mark is introduced into a pre-aligner of a lithographic apparatus; the position of the substrate is measured using an edge detector and the location of the alignment mark is measured using a detector; the substrate is flipped over so that the alignment mark is on a lower most surface of the substrate; after flipping over the substrate, the position of the substrate is measured using the edge detector, and the location of the alignment mark is measured using the detector via the detector looking through the substrate; and the difference between the measured locations of the alignment mark is determined.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts the production of a substrate on a carrier;

FIG. 3 depicts a substrate table of the lithographic apparatus of FIG. 1;

FIG. 4 depicts a pre-aligner of the lithographic apparatus of FIG. 1;

FIG. 5 depicts a thin substrate on a carrier; and

FIG. 6 depicts a calibration method according to an embodiment of the invention.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

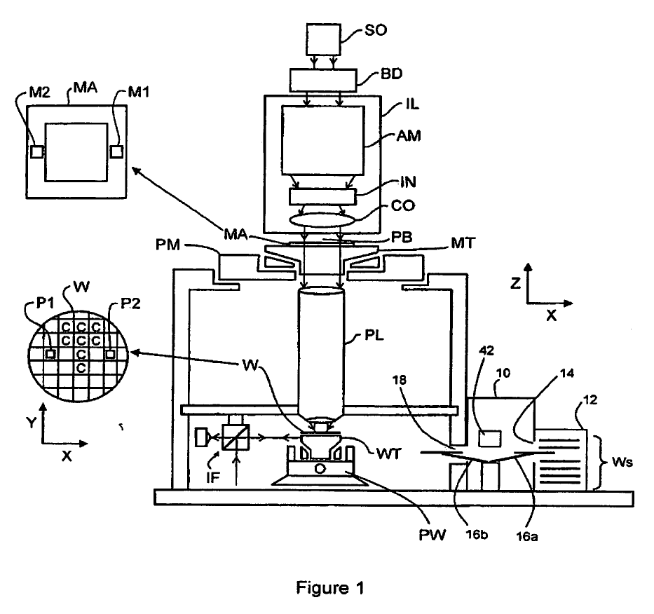

FIG. 1 schematically depicts a lithographic apparatus according to a particular embodiment of the invention. The apparatus comprises:
an illumination system (illuminator) IL to condition a beam PB of radiation (e.g. UV radiation or DUV radiation);
a support structure (e.g. a mask table) MT to support a patterning device (e.g. a mask) MA and connected to first positioning device PM to accurately position the patterning device with respect to item PL;
a substrate table (e.g. a wafer table) WT for holding a substrate (e.g. a resist-coated wafer) W and connected to second positioning device PW to accurately position the substrate with respect to item PL; and
a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjusting means AM for adjusting the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The illumination system may also encompass various types of optical components, including refractive, reflective, and catadioptric optical components for directing, shaping, or controlling the beam of radiation, and such components may also be referred to below, collectively or singularly, as a “lens”.

The radiation beam PB is incident on the patterning device (e.g. mask) MA, which is held on the support structure MT. Having traversed the patterning device MA, the beam PB passes through the lens PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The lithographic apparatus may be of a type having two (dual stage) or more substrate tables (and/or two or more support structures). In such “multiple stage” machines the additional tables and/or support structures may be used in parallel, or preparatory steps may be carried out on one or more tables and/or support structures while one or more other tables and/or support structures are being used for exposure.

The lithographic apparatus may also be of a type wherein the substrate is immersed in a liquid having a relatively high refractive index, e.g. water, so as to fill a space between the final element of the projection system and the substrate. Immersion techniques are well known in the art for increasing the numerical aperture of projection systems.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 1 also shows a pre-aligner 10 and a substrate delivery apparatus 12, each of which may form part of the lithographic apparatus. The substrate delivery apparatus 12 may hold one or more batches of substrates (a batch may for example be 25 substrates). This is represented schematically by six substrates Ws within the substrate delivery apparatus. An opening 14 is provided between the substrate delivery apparatus 12 and the pre-aligner 10. A moveable arm 16 is used to transfer a substrate from the substrate delivery apparatus 12 via the pre-aligner 10 to the substrate table WT of the lithographic apparatus.

Although there is only one moveable arm, FIG. 1 shows the moveable arm in two positions 16a, 16b for illustrative purposes. In the first position 16a, the moveable arm retrieves a substrate W from the substrate delivery apparatus 12 via the opening 14. In the second position the moveable arm 16b moves the substrate W towards the substrate table WT through a second opening 18.

In use, a substrate W is passed from the substrate delivery apparatus 12 to the substrate table WT by the moveable arm 16. The substrate is then exposed using the lithographic apparatus. Following exposure the substrate W is retrieved from the substrate table WT by the moveable arm 16 and returned to the substrate delivery apparatus 12. A new substrate W is then passed from the substrate delivery apparatus 12 to the substrate table WT for exposure, and so on.

In some cases the pre-aligner may be provided with more than one arm (or some other mechanism), to allow the new substrate to be taken from the substrate delivery apparatus 12 before the exposed substrate has been returned to the substrate delivery apparatus. This increases the throughput of the lithographic apparatus by reducing the time taken to exchange substrates at the substrate table WT. In some cases the substrate delivery apparatus may include a substrate transport mechanism, such as a conveyor belt for example, to carry substrates to the moveable arm 16. This may be the case, for example, if the substrate delivery apparatus is capable of holding several batches of substrates.

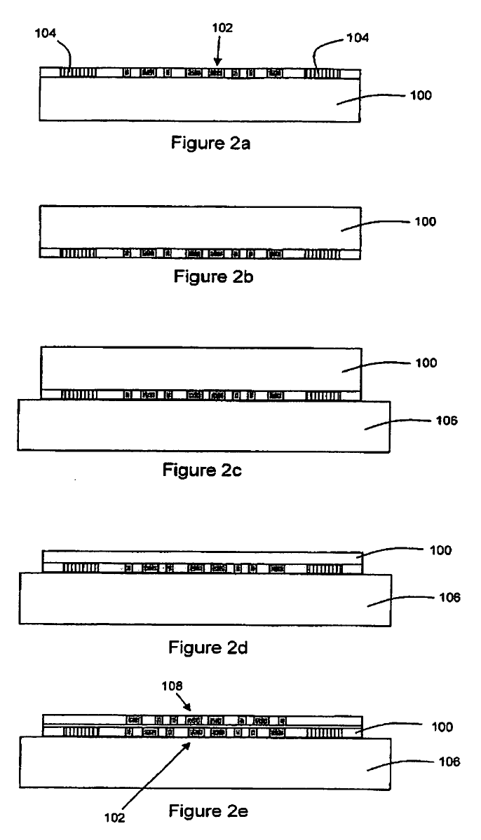

FIG. 2 shows schematically a series of steps which may be performed in the production of a so-called thin substrate. The term thin substrate is generally used to mean a substrate which has a thickness substantially less than the conventional wafer thickness of around 700 microns. A thin substrate may, for example, have a thickness less than 200 microns, or less than 100 microns. The thin substrate may, for example, have a thickness of 75 microns or less, or a thickness of 25 microns or less. The thin substrate may, for example, have a thickness of 10 microns or less. Referring to FIG. 2a, a substrate 100 of conventional thickness is provided. The substrate may, for example, comprise GaAs or Si (i.e. the substrate may be a conventional lithographic wafer). A lithographic apparatus is used to expose a pattern 102 at an upper surface of the substrate 100. In addition to the pattern 102, one or more alignment marks 104 are also formed on the substrate 100. Although only one patterned layer is shown in FIG. 2a, a plurality of patterned layers may be formed on the upper surface of the substrate 100.

The patterned substrate is inverted as shown in FIG. 2b, and is then bonded to a carrier 106 as shown in FIG. 2c. The carrier may, for example, be made from a glass, quartz, silicon or some other suitable material. The substrate 100 is then ground away as shown in FIG. 2d. The removal of the substrate 100 continues until, for example, between 25 and 100 microns thickness of the substrate 100 remains. In this way a thin substrate 100 supported on a carrier 106 is provided.

As shown in FIG. 2e, a subsequent pattern layer 108 may be exposed on the upper surface of the thin substrate 100 (formerly the bottom surface of the substrate). In many instances it will be desirable for the pattern exposed on the upper surface of the substrate to align correctly with the pattern already provided on the lower surface of the substrate. One way in which this may be achieved is by using a so-called front to backside alignment system, for example as described in U.S. Pat. No. 6,768,539, which is incorporated herein in its entirety by reference. Although a separation is shown between the upper pattern 108 and lower pattern 102, in some cases the upper and lower patterns may be in contact with each other.

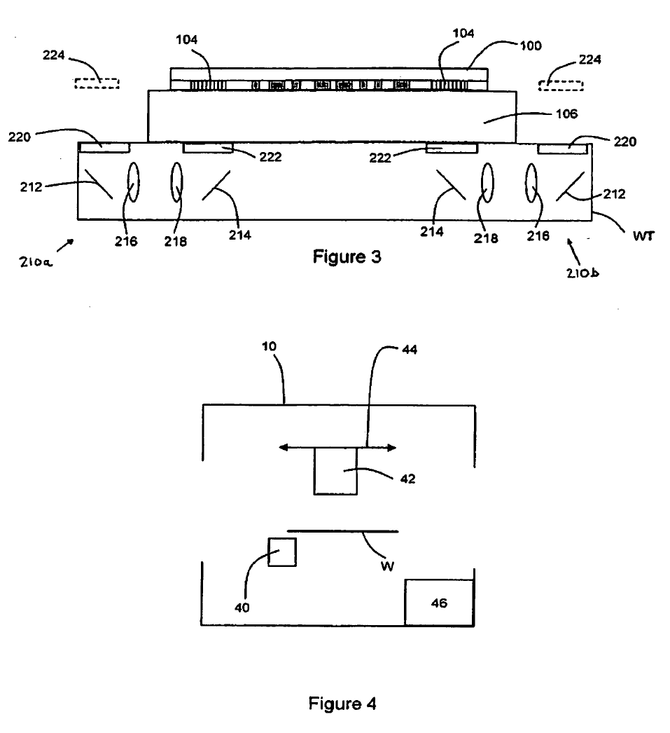

FIG. 3 shows the substrate 100 and carrier 106 of FIG. 2 on the substrate table WT. Alignment marks 104 are provided on a backside of the substrate 100. An optical system is built into the substrate table WT to provide optical access to the alignment marks 104, via the carrier 106 (which is transparent). The optical system comprises a pair of arms 210a, 210b. Each arm comprises two mirrors, 212, 214 and two lenses 216, 218. The mirrors 212, 214 in each arm are inclined such that the sum of the angles that they make with the horizontal is 90°. In this way, a beam of radiation impinging vertically on one of the mirrors will remain vertical when reflected off the other mirror. Of course, other ways of obtaining the 180° change in direction can be thought of. For instance, the lenses and the mounting may be designed in such a way that they may take account of a large part of the direction change, as long as the total of the optical system provides a direction change of 180°. Windows 220, 222 are provided in the substrate table WT above the mirrors 212, 214. The windows may be formed from quartz, or some other material which is transparent to radiation used to view the alignment marks 104. The windows may simply be openings (i.e. contain no material).

In use, radiation is directed from above the substrate table WT into arm 210a and/or arm 210b through window 220 onto mirror 212, through lenses 216 and 218, onto mirror 214 and then through window 222. The radiation passes upwards through the carrier 106 onto the respective alignment marks 104. Radiation is reflected off portions of the respective alignment marks 104 and returns along the respective arms of the optical system. The mirrors 212, 214 and lenses 216, 218 are arranged such that an image 224 is formed of each alignment mark 104. As will be appreciated, only one alignment mark 104 may be provided. Similarly, only one arm 210a or 210b may be provided or used at one time, if desired.

The image 224 of an alignment mark 104 act as a virtual alignment mark, and may be used for alignment by an alignment system (not shown) in the lithographic apparatus in the same way as an alignment mark which is conventionally positioned on an upper surface of the substrate 100. The alignment system may be a conventional alignment system. Such systems are well known to those skilled in the art and are therefore not described here.

FIG. 4 shows schematically the pre-aligner shown in FIG. 1. For ease of illustration, the moveable arm is not shown, although it is conventionally present within the pre-aligner. A substrate W is located within the pre-aligner. An edge-sensor 40 which is arranged to detect the position of an edge of the substrate is provided in the pre-aligner. There is also provided an imaging detector 42.

It is conventional to use the edge-sensor 40 to measure the position of an edge of the substrate W, and thereby determine the position of the substrate W when it is in the pre-aligner. Using knowledge of the position of the substrate W in the pre-aligner it is possible to determine where on the substrate table WT the substrate W is located once the substrate has been passed to the substrate table. Generally speaking the position of the substrate W upon the substrate table WT is known to within around 10 microns.

An alignment sensor (not shown) within the lithographic apparatus is conventionally used to determine the position of target portions of the substrate, so as to ensure that a pattern projected onto the substrate is correctly aligned with a pattern previously provided in the target portions. The alignment sensor measures the position of alignment marks P1, P2 (see FIG. 1) on the substrate. The capture range of the alignment sensor may be limited, for example, to a few tens of microns. It is conventional to position the substrate table WT such that one or more of the alignment marks P1, P2 are located beneath the alignment system with an error which is less than the capture range of the alignment sensor. The measurement of the position of the substrate W in the pre-aligner 10 using the edge-sensor 40 is needed to ensure that the position of the substrate upon the substrate table is known, which in turn allows the substrate table to be positioned such that the alignment mark(s) P1, P2 falls within the capture range of the alignment system.

The above described method for having one or more of the alignment marks located within the capture range of the alignment system may fail when applied to a thin substrate bonded to a transparent carrier. FIG. 5 shows, viewed from above, the thin substrate 100 bonded to the carrier 106. It can be seen that the substrate 100 is not located in the center of the carrier 106. The edge detector 40 will detect the position of the edge of the substrate carrier 106, rather than the edge of the substrate 100. Since the misalignment of the substrate with respect to the substrate carrier may be substantial, detection of the position of the edge of the substrate carrier may not be sufficiently accurate to ensure that an alignment mark provided on an upper surface of the substrate 100 falls within a capture range of the alignment system. In some instances the edge of the carrier 106 may be damaged, for example when grinding away the substrate. This may reduce the accuracy with which the location of the substrate 100 may be determined based upon the position of the edge of the carrier 106.

In a conventional method the substrate W does not need to be accurately located at a specific position on the substrate table WT, provided that its position on the substrate table WT is known. This is because the substrate table WT may be moved in the x and y directions such that an alignment mark P1, P2 provided on an upper surface of the substrate falls within a capture range of the alignment system. This is not the case when using the front to backside alignment system.

Referring to FIG. 3, it can be seen that the substrate 100 should be positioned on the substrate table WT such that the one or more alignment marks 104 are located above the respective one or more windows 222. This is to ensure that the one or more alignment marks 104 are visible through the respective one or more windows 222, and therefore can form one or more alignment mark images 224 which may be used for alignment. If the substrate 100 is incorrectly positioned on the substrate table WT such that the one or more alignment marks 104 are not visible through the respective one or more windows 222, then no amount of movement of the substrate table WT will correct for this, since the position of the substrate 100 upon the substrate table is fixed.

An embodiment of the invention helps to solve the above or other problem by using an imaging detector 42 which is located above the substrate 100 and carrier 106 in the pre-aligner 10. The imaging detector emits a beam of radiation which is non-actinic (i.e. radiation which has a wavelength sufficiently long that it will not cause conventional lithographic resist to be exposed). The radiation is used to illuminate an area of the substrate 100 which is seen by the imaging detector 42. The radiation emitted by the imaging detector 42 includes infrared radiation. When a thin substrate 100 is positioned beneath the imaging detector 42, the infrared radiation passes through the substrate 100 to a sufficient degree that the one or more alignment marks 104 on the bottom side of the substrate 100 are visible to the imaging detector 42. The imaging detector 42 is therefore able to accurately measure the location of the one or more alignment marks 104 on the bottom side of the substrate.

In use, a substrate carrier 106 (and associated substrate 100) is retrieved from the substrate delivery apparatus 12 using the moveable arm 16. The moveable arm 16 passes the substrate carrier 106 beneath the imaging detector 42. The imaging detector 42 measures the position of the one or more alignment marks 104 on the bottom side of the substrate 100. The substrate carrier 106 is then passed to the substrate table WT by the moveable arm 16, the substrate carrier being positioned on the substrate table WT such that the one or more alignment marks 104 are located above the respective one or more windows 222 in the substrate table.

Once the substrate carrier 106 has been positioned upon the substrate table WT, alignment of the substrate for exposure may be achieved by the alignment system aligning to the virtual alignment mark(s) 224.

The imaging detector 42 may include pattern recognition software, to allow the alignment mark(s) 104 to be identified in an automated manner. The capture range of the imaging detector 42 may be, for example, around 900 microns in the x and y directions. Typically the imaging detector 42 will include an objective lens which provides magnification. The capture range of the imaging detector 42 may be increased by providing the imaging detector with an objective lens having a lower magnification. However, the magnification of the objective lens should not be reduced so much that the imaging detector is no longer able to see the alignment mark(s).

A controller 46 may be arranged to automatically move the substrate 100 and/or the imaging detector 42 through a range of motion such that a location in which an alignment mark is expected passes beneath the imaging detector 42 (i.e. within the capture range of the imaging detector). The motion may be arranged, for example, such that a spiral movement is established between the substrate and the imaging detector. Alternatively, a linear movement (in the x and y directions) may be used. The capture range provided by the automated movement may be, for example, 50 mm. If this automated process fails to locate any alignment mark, or a sufficient number of alignment marks, then a manual override may be used to locate an alignment mark. The manual override comprises an interface (such as a joystick) which may be used to move the substrate 100 and/or the imaging detector 42. A display screen may display the image seen by the imaging detector 42 to assist the user in finding an alignment mark.

The imaging detector 42 may be mounted on a rail 44 which allows the imaging detector to be moved in a direction substantially parallel to the surface of the substrate 100. The imaging detector 42 may be mounted such that it is moveable in two directions substantially parallel to the surface of the substrate 100. This may allow, for example, the imaging detector 42 to be positioned over all locations of the substrate. The imaging detector 42 may also move in any other direction.

The movement of the imaging detector 42 may be restricted, for example to a particular direction of movement. This may be selected such that the movement of the imaging detector 42, together with movement of the substrate provided by the moveable arm 16 is sufficient to allow all parts of the surface of the substrate W to be seen by the imaging detector, or those parts of interest (i.e. a location where an alignment mark is expected to be found).

In an embodiment, an alignment mark may be provided on an upper surface of the substrate W, and may have a known positional relationship with respect to one or more alignment marks 104 provided on the lower surface of the substrate. When this is the case, the imaging detector 42 may be used to determine the position of the alignment mark provided on the upper surface of the substrate. The position of one or more alignment marks 104 provided on the lower surface of the substrate may then be calculated. Once the position of the one or more alignment marks 104 on the lower surface of the substrate 100 have been calculated, the substrate may be correctly be positioned on the substrate table WT such that the one or more alignment marks 104 on the lower surface of the substrate are visible through the respective one or more windows 222 in the substrate table WT.

In an embodiment, an additional alignment mark may be provided on the lower surface of the substrate 100, and may have a known positional relationship with respect to one or more alignment marks 104 which are designed to be located above the respective one or more substrate table windows 222. When this is the case the imaging detector 42 may be used to determine the position of the additional alignment mark. The position of the one or more alignment marks 104 to be used for front to backside alignment may then be calculated. Once the position of the one or more alignment marks 104 to be used for front to backside alignment have been calculated, the substrate may be correctly positioned on the substrate table WT such that the one or more alignment marks 104 are visible through the respective one or more windows 222 in the substrate table WT.

In the above description the substrate 100 has been described as being formed from GaAs or Si. However, it will be appreciated that the substrate may be formed from any other suitable material(s). The imaging detector 42 may use radiation which has a wavelength such that it is capable of penetrating through the material of the substrate, thereby allowing one or more alignment marks 104 provided on a lower surface of the substrate to be seen by the imaging detector.

It is not necessary for the imaging detector 42 to resolve a high definition image of the one or more alignment marks 104. All that is required is that the imaging detector 42 finds the location of the one or more alignment marks 104 with a sufficient accuracy that they can be correctly located over the respective one or more windows 222 of the substrate table WT.

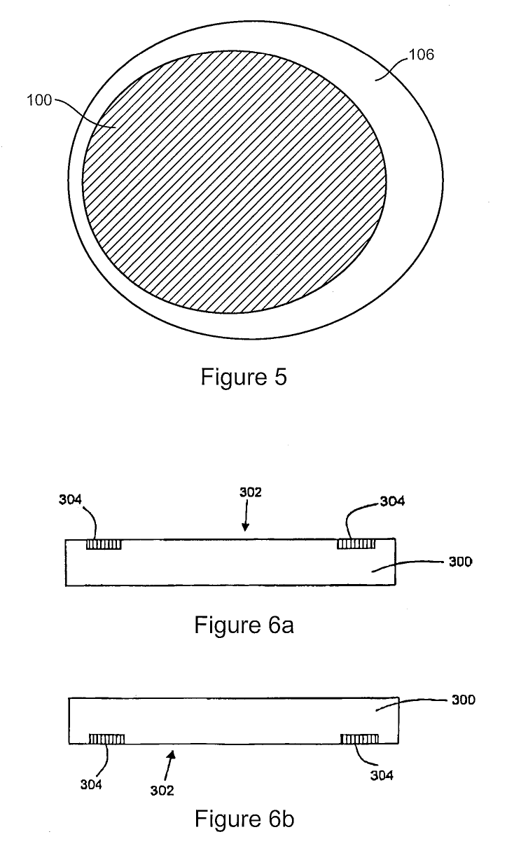

A method according to an embodiment of the invention is illustrated schematically in FIG. 6. The method is a calibration method. Referring to FIG. 6a, a calibration substrate 300 is provided with one or more alignment marks 304 on its upper surface. The calibration substrate is introduced into the pre-aligner of the lithographic apparatus described above. The imaging detector 42 is used to measure the location of the one or more alignment marks 304. The substrate is then flipped over, so that the alignment marks 304 are on a lower most surface of the substrate 300. It may be necessary to remove the substrate from the pre-aligner before it can be flipped over and then the substrate is reintroduced into the pre-aligner of the lithographic apparatus. The position of the one or more alignment marks 304 on the lower most surface of the substrate are measured using the imaging detector 42, radiation passing through the substrate 300 in order to allow the alignment one or more marks 304 to be seen by the imaging detector 42.

In addition to measuring the position of the one or more alignment marks 304, the edge sensor 40 is used to determine the position of the substrate. Since the substrate 300 is a conventional substrate and is not bonded to a carrier, the edge sensor allows a reasonably accurate determination of the location of the substrate to be measured. This in turn allows the position of the one or more alignment marks 304 as measured by the imaging detector 42 to be related to the position of the substrate as measured by the edge detector 40.

The substrate 300 may be circular but with a flat edge provided on a portion of its periphery. This is a conventional substrate format, and will be known to those skilled in the art. The so-called flat-edge of the substrate is usually positioned at the same location in the pre-aligner. This allows rotational error in the position of the substrate within the pre-aligner to be avoided or minimized.

Since the position of the substrate is measurable using the edge detector 40, the position of the one or more alignment marks 304 on the substrate before and after flipping of the substrate may be measured. This provides useful calibration information.

In an embodiment of the invention, in addition to providing the imaging detector 42 above the substrate W, a further imaging detector may be provided beneath the substrate. Where this is done, the calibration measurement described above is simplified, since flipping of the substrate is no longer necessary.

The terms “view” or “visible” herein include more than visibility to the naked eye as a possibility. In the context of an alignment mark, these terms are used more generally to refer to the ability of, or an arrangement to allow, a detector to detect the alignment mark using, for example, radiation.

Although the described embodiment uses an imaging detector 42, any other form of detector may be used. For example, the detector may be configured to view a diffraction pattern generated by the one or more alignment marks 104.

While specific embodiments of the invention have been described above, it will be appreciated that the invention may be practiced otherwise than as described. The description is not intended to limit the invention.

1. A lithographic apparatus, comprising:
a projection system configured to project a patterned radiation beam onto a target portion of a substrate;
a substrate table configured to position the substrate such that the patterned beam is incident upon the substrate, the substrate table comprising a window; and
a pre-aligner comprising:
a detector configured to view an alignment mark provided on a side of a substrate which is opposite to the location of the detector, and
a controller arranged to measure the location of the alignment mark provided on the opposite side of the substrate, and to position the substrate onto the substrate table such that the alignment mark provided on the opposite side of the substrate is visible through the window of the substrate table.

2. The lithographic apparatus of claim 1, wherein the detector comprises a source of infra-red radiation arranged to illuminate the substrate such that the alignment mark is visible to the detector.

3. The lithographic apparatus of claim 1, wherein the detector is an imaging detector.

4. The lithographic apparatus of claim 1, wherein the detector is moveable relative to the substrate so that the alignment mark can be seen by the detector.

5. A method, comprising:
introducing a substrate into a pre-aligner of a lithographic apparatus;
using a detector to measure the location of an alignment mark provided on a side of the substrate which is opposite to the location of the detector; and
after measurement, putting the substrate onto a substrate table of the lithographic apparatus, the substrate being positioned on the substrate table such that the alignment mark provided on the opposite side of the substrate is visible through a window of the substrate table.

6. The method of claim 5, wherein the substrate has a thickness of less than 200 microns and is supported by a carrier.

7. The method of claim 6, wherein the substrate has a thickness of less than 100 microns and is supported by a carrier.

8. The method of claim 7, wherein the substrate has a thickness of less than 25 microns and is supported by a carrier.

9. The method of claim 5, wherein the carrier is glass, quartz or silicon.

10. The method of claim 5, wherein the detector illuminates the alignment mark with infrared radiation such that the alignment mark is visible to the detector.

11. The method of claim 5, wherein the detector, or the substrate, or both the substrate and the detector are moved relative to one another so as to position the alignment mark such that the alignment mark can be seen by the detector.

12. The method of claim 5, wherein the method is automated.

13. A calibration method in which:
a substrate bearing an alignment mark is introduced into a pre-aligner of a lithographic apparatus;
the position of the substrate is measured using an edge detector and the location of the alignment mark is measured using a detector;
the substrate is flipped over so that the alignment mark is on a lower most surface of the substrate;
after flipping over the substrate, the position of the substrate is measured using the edge detector, and the location of the alignment mark is measured using the detector via the detector looking through the substrate; and
the difference between the measured locations of the alignment mark is determined.

14. The method of claim 13, wherein the substrate is removed from the pre-aligner before the substrate is flipped over.

15. The method of claim 13, wherein the substrate includes a flat-edge which is used by the pre-aligner to position the substrate prior to measurements being performed.

16. The method of claim 13, wherein the detector is an imaging detector.
